(19) United States
(12) Patent Application Publication
(10) Pub. No.: US 2010/0045598 A1
(43) Pub. Date: Feb. 25, 2010

(54) APPARATUS FOR CONTROLLING THE MOVEMENT OF AN OBJECT ON A PLANE

(75) Inventors: Robert E. DeMers, Elk River, MN (US); Chad Langness, St. Paul, MN (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/195,268

(22) Filed: Aug. 20, 2008

(51) Int. Cl. G06F 3/033; G05B 15/00

(52) U.S. Cl. 345/158; 700/275

(57) ABSTRACT

An apparatus is provided for controlling the movement of an object on a plane. The apparatus comprising a basin, a movable object positioned within the basin, and a sensor coupled to the apparatus for detecting the movement of the movable object within the basin, wherein the movement of the object on the plane is related to movement of the object within the basin.

### TECHNICAL FIELD

The present invention generally relates to electronic user interfaces, and more particularly relates to an apparatus for controlling the movement of an object on a plane.

### BACKGROUND

Increasingly, vehicles are being configured with electronic display systems that depict a plurality of images. These electronic display systems may include a cursor control device for manipulating a movable cursor on these images. These cursor control devices may be any one of a number of cursor control devices, including a mouse control, a joystick control, or a trackball control. Electronic display systems provide a user with useful information regarding the state of the vehicle, the surrounding area, or other data regarding the vehicle's environment.

While the use of standard cursor control devices on a vehicle is effective, it does suffer from certain drawbacks. For example, the use of a mouse control requires an immobile flat surface that the control slides across to direct the movement of the cursor. However, the surfaces inside of a moving vehicle vibrate and are subject to other forces that make the use of a mouse control difficult. In addition, it is possible for the mouse control to slide completely off of a surface of the vehicle when the vehicle turns or stops suddenly. In addition, while the use of a joystick control or a trackball control may be better suited for use in a vehicle (e.g., because these controls are coupled to a base), many users prefer to use a mouse control as it provides them with an intuitive sense for directing the movement of a cursor.

Accordingly, it is desirable to provide a cursor control device for use on a vehicle that is not affected by vibrations and other forces. In addition, it is desirable to provide a cursor control device that has the same intuitive feel as a mouse control. Furthermore, other desirable features and characteristics of the present invention will become apparent from the subsequent detailed description of the invention and the appended claims, taken in conjunction with the accompanying drawings and this background of the invention.

### BRIEF SUMMARY

An apparatus is provided for controlling the movement of an object on a plane. The apparatus comprises a basin, a movable object positioned within the basin, and a sensor coupled to the apparatus for detecting the movement of the movable object within the basin, wherein the movement of the object on the plane is related to movement of the movable object within the basin.

### BRIEF DESCRIPTION OF THE DRAWINGS

The present invention will hereinafter be described in conjunction with the following drawing figures, wherein like numerals denote like elements, and

FIG. 1. is a cross-sectional view of a device for controlling the movement of an object on a plane according to a first embodiment of the present invention;

FIG. 2 is a cross-sectional view of a device for controlling the movement of an object on a plane according to a second embodiment of the present invention; and

FIG. 3 is a block diagram of a system for controlling the movement of a cursor on an electronic display.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

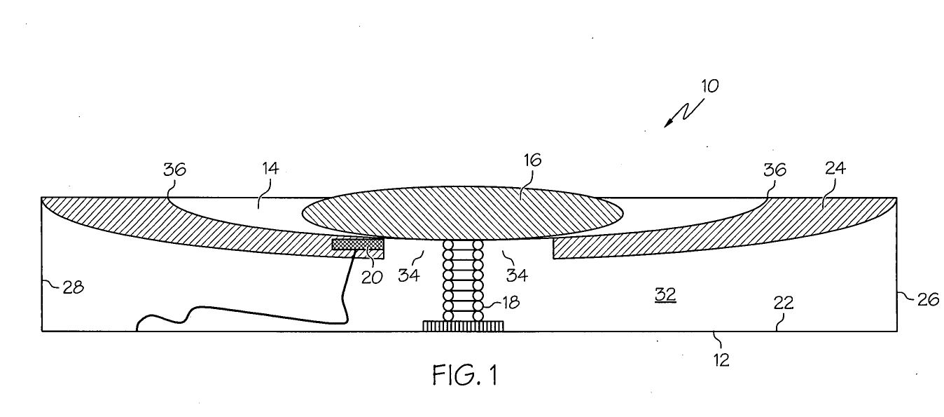

FIG. 1 is a cross-sectional view of a device 10 for controlling the movement of an object on a plane according to a first embodiment of the present invention. As further described below, in one embodiment device 10 comprises a cursor control device for controlling the movement of a cursor on an electronic display. The cursor control device may be used on a vehicle (e.g., ground, air, space, or submersible) or at any other location where a user interacts with an electronic display. It will be understood by one who is skilled in the art that device 10 may be used to control any object that moves on a plane, such as a robotic pen, a milling machine having a cutting apparatus that moves about two axes, or a vehicle that travels on a surface.

As depicted, device 10 includes a base 12, a basin 14, a movable object 16, a spring 18, and a sensor 20. The base 12 includes a bottom 22, a top 24, and one or more sides (e.g., two as shown) 26, 28. The bottom 22 is of sufficient shape and size to provide support for device 10. The top 24 of base 12 is positioned above the bottom 22 and is supported by the sides 26, 28. The bottom 22, top 24 and sides 26, 28 of base 12 form an inner chamber 32.

Basin 14 having a predetermined curvature is formed in the upper surface of the top 24 of base 12. In one embodiment basin 14 is circular. The curvature of basin 14 is determined based on desired characteristics of device 10 such as its desired size or the range of movement of movable object 16 described below. Basin 14 also includes an opening 34 positioned at its center. The opening 34 extends through basin 14 to inner chamber 32.

Movable object 16 is normally positioned at the center of basin 14, and has larger dimensions than opening 34, preventing it from passing through opening 34. The user of device 10 slides the object 16 along the surface of basin 14 to control the movement of a cursor on an electronic display (or any object that moves along a plane) in a fashion similar to the use of a mouse control. Object 16 follows the curvature of basin 14 providing the feeling that it is pivoting about a point above device 10 as it moves from one side of basin 14 to another. Object 16 and basin 14 may each comprise a low-friction material to allow for smooth and low effort motion. In one embodiment, object 16 is a substantially circular disc having a curvature that is substantially complementary to the curvature of basin 14.

Movable object 16 is coupled to bottom component 22 of base 12 via spring 18. Spring 18 is coupled to movable object 16 at one end, passes through opening 34 of basin 14, and is coupled to the bottom 22 of base 12 at the opposite end. Spring 18 is in its relaxed state when movable object 16 is positioned at the center of basin 14. As movable object 16 is displaced from the center of basin 14, spring 18 deflects away from its relaxed state. When movable object 16 is released, spring 18 returns to its relaxed state and causes movable object 16 to return to the center of basin 14. Thus, spring 18 biases object 16 toward the center of basin 14. In addition, spring 18 constrains the movement of movable object 136 preventing it from being removed from basin 134 due to vibrations or other forces inside of the moving vehicle. The spring 18 and the curvature of basin 14 work together to restrict the movement of movable object 16 within a predetermined range of motion. For example, the range of motion for the movable object 16 may be restricted to basin 14 such that movement of object 16 is inhibited when its edge meets with the outer rim 36 of basin 14. Although in the depicted embodiment the movement of movable object 16 is constrained via spring 18, it should be noted that other restraint devices may also be used. For example, a retractable cord or any other mechanism may be coupled to movable object 16 and to base 12 to constrain the movement of movable object 16.

Sensor 20 detects the movement of the object 16 within the basin 14. In the depicted embodiment, sensor 20 is an optical sensor mounted near the rim of opening 34. As object 16 slides along the surface of basin 14, optical sensor 20 generates motion signals that describe the movement of object 16. When object 16 is lifted away from the surface of basin 14, sensor 20 is unable to detect its movement or to generate motion signals.

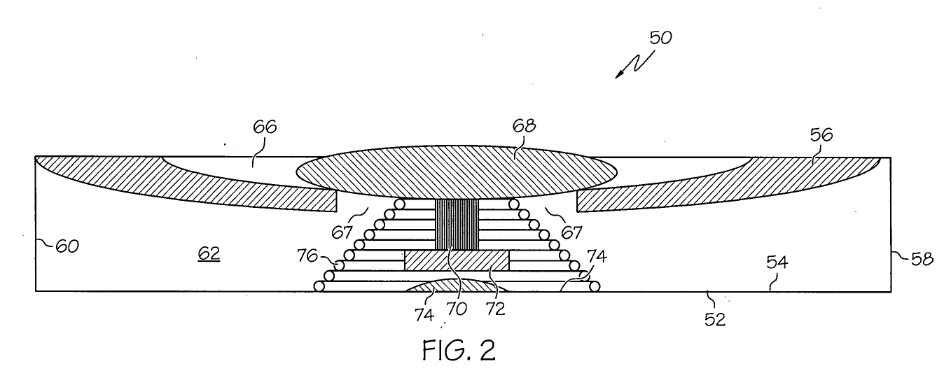

Other types of sensors may also be used with embodiments of the present invention. For example, FIG. 2 is a cross-sectional view of a device 50 for controlling the movement of an object on a plane according to a second embodiment of the present invention. As depicted, device 50 includes a base 52 that comprises a bottom 54, a top 56, and one or more sides 58, 60. The bottom 54, top 56, and sides 58, 60 form an inner chamber 62. A basin 66 is formed into the upper surface of the top 56 of base 52. Basin 66 has an opening 67 in its center that extends into the inner chamber 62. A movable object 68 is positioned in basin 66. In this embodiment, movable object 68 also includes a downwardly extending stem 70 that extends through opening 67 into the inner chamber 62. A magnet 72 is coupled to the end of stem 70 and a Hall Effect sensor 74 is mounted to the bottom 54 of base 52, directly beneath the magnet 72. Hall Effect sensor 74 detects movement of the magnet 72 when the movable object 68 is displaced and generates motion signals describing that movement.

In addition, this embodiment includes a conically shaped spring 76 for biasing movable object 68 toward the center of basin 66 and constraining its movement as described above. The spring encompasses stem 70, magnet 72, and Hall Effect sensor 74. In other embodiments, spring 76 may comprise a plurality of smaller springs formed in a conical arrangement around stem 70, magnet 72, and Hall Effect sensor 74. In addition, in still other embodiments magnet 72 may be placed within movable object 68 and Hall Effect sensor 74 may be placed near the rim of opening 67.

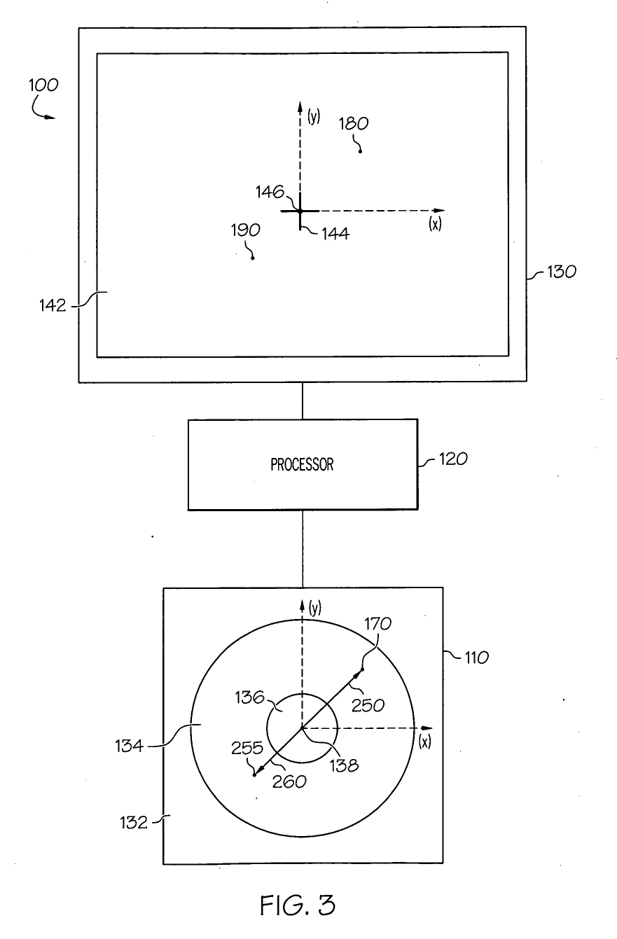

FIG. 3 is a block diagram of an exemplary system 100 for use with embodiments of the present invention. As depicted, the system 100 includes a cursor control device 110, a processor 120, and an electronic display 130. The cursor control device 110 corresponds to device 10 of FIG. 1 (or, alternatively, device 50 of FIG. 2). The cursor control device 110 is coupled to the processor 120 and includes a base 132, a basin 134, and a movable object 136 positioned in the center of the basin 134. Object 136 is movable within a coordinate system 138 having X and Y-axes. Movement of object 136 is constrained to a predetermined range of motion. A sensor (e.g., the sensor 20 of FIG. 1) on the cursor control device 110 generates motion signals that describe the movement of movable object 136 within basin 134.

The electronic display 130 is coupled to processor 120 and includes a display area 142. The display area 142 displays an image that includes a cursor 144 that is movable within a coordinate system 146 which corresponds to coordinate system 138 of the cursor control device 110. As described below, the movement of the cursor 144 within the image depicted in display area 142 is based on command signals that the electronic display 130 receives from the processor 120 in response to the motion signals that the processor 120 receives from the cursor control device 110.

Processor 120 is coupled to cursor control device 110 and electronic display 130. It receives motion signals describing the movement of movable object 136 within basin 134 from cursor control device 110. In response to these motion signals, processor 120 determines the proper position for cursor 144 on the image depicted in the display area 142 and transmits a command signal to the electronic display 130. The electronic display 130 displays the cursor 144 in the appropriate position.

The processor 120 moves cursor 144 across the image depicted on display area 142 in accordance with one of a plurality of modes. In a first mode (e.g., an absolute mode) each position within the range of motion of movable object 136 corresponds to a predetermined position of cursor 144 on the image depicted in display area 142. Thus, the position of cursor 144 is at all time synchronized to the position of movable object 136 and the user may position cursor 144 at a desired location on the image by positioning movable object 136 at a corresponding position within basin 134.

For example, the normal position of movable object 136 (e.g., the center of the basin 134) may correspond to the center of the image and each position at the border of the range of motion of movable object 136 may correspond to a position on the border of the image. In this case, when movable object 136 is positioned at the center of basin 134, the processor 120 positions cursor 144 at the center of the image depicted on the display area 142. If the user moves object 136 to a position at the border of its range of motion, processor 120 moves cursor 144 in a synchronized manner to a corresponding location on the edge of the image. Further, if movable object 136 is moved to a position 170 within basin 134 that corresponds to position 180 on the image depicted in the display area, processor 120 moves cursor 144 in a synchronized manner to the corresponding position on the image.

In a second mode of operation (e.g., a relative mode) movement of movable object 136 within basin 134 results in a corresponding movement of cursor 144 on the image depicted in display area 142. However, the position of cursor 144 on the image does not necessarily correspond to the position of movable object 136 within basin 134. For the purposes of describing the movement of movable object 136 and cursor 144 in relative mode, the origin of coordinate system 138 will at all time be positioned at the center of movable object 136 and the origin of coordinate system 146 will at all times be positioned at the center of cursor 144. In this mode, if the user desires to move cursor 144 from its current position (e.g., the center of the image) to position 180, the user moves object 136 in a direction within coordinate system 138 that corresponds to the direction of position 180 with respect to the origin of coordinate system 146. Cursor 144 moves in the direction at a speed that corresponds to the speed of movable object 136. Further, if the user then desires to move cursor 144 from position 180 to position 190 on the image depicted in display area 142, the user moves object 136 from its current position in a direction within coordinate system 138 that corresponds to the direction of position 190 with respect to the origin of coordinate system 146.

If movable object 136 reaches the border of its range of motion before cursor 144 reaches a desired location on the image, the position of movable object 136 must be reset within basin 134 before cursor 144 can continue moving toward the desired location. In one embodiment, movable object 136 may be reset by lifting it upward against the force of the spring 18 (FIG. 1) and away from the surface of basin 134 and the sensor 20 (FIG. 1). Movable object 136 may then be moved away from the border of its range of motion, set back down at desired location on the surface of basin 134, and moved in the appropriate direction. This process may repeat until cursor 144 reaches the desired position.

In a third mode of operation (e.g., a rate mode), cursor 144 moves on the image depicted in display area 142 in a direction that is based on the position of movable object 136 with respect to the center of basin 134 and at a speed that is determined by the distance between the center of movable object 136 and the center of basin 134. In rate mode, the origin of coordinate system 138 is positioned at all times at the center of basin 134 and the origin of coordinate system 146 is positioned at the center of cursor 144. The movable object 136 may be displaced from the center of the basin 134 to position 170. This displacement can be described by a vector 250 beginning at the origin of coordinate system 138 (e.g., the center of basin 134) and ending at position 170. In response, the processor 120 moves the cursor 144 across the image in the display area 142 in a direction within coordinate system 146 that corresponds to the direction of vector 250 within coordinate system 138. Cursor 144 accelerates in the appropriate direction until it reaches a speed that corresponds to the magnitude of vector 250 (e.g., the distance between the center of movable object 136 and position 170). If the user desires to change the direction or speed of cursor 144, the user may move object 136 to another position 255 within basin 134. In this case, vector 260 describes the new position 260 of movable object 136. Processor 120 would then move cursor 144 in a direction with respect to coordinate system 146 that corresponds to the direction of vector 260 within coordinate system 138 and the speed of cursor 144 would change to correspond to the magnitude of vector 260 (e.g., the distance between the center of basin 134 and position 255). When the movable object 136 is returned to the center of the basin 134, movement of the cursor 144 ceases.

Finally, in a fourth mode of operation (e.g., an acceleration mode) the cursor 144 accelerates across the image depicted in the display area 142 in a direction that is based on the orientation of the movable object 136 with respect to the center of basin 134 and at a rate that is based on the distance between the center of basin 134 and the center of movable object 136. In acceleration mode, the origin of coordinate system 138 is positioned at all times at the center of basin 134 and the origin of coordinate system 146 is positioned at the center of cursor 144. When movable object 136 is displaced from the center of the basin 134 to position 170, processor 120 accelerates cursor 144 on the image depicted in display area 142 in a direction that corresponds to the direction of vector 250. The acceleration of cursor 144 depends on the distance between the centers of basin 134 and position 170. If movable object 136 is moved further away from basin 134, processor 120 will cause cursor 144 to accelerate in the appropriate direction at in increased rate. Conversely, if movable object 136 is moved closer to basin 134, processor 120 accelerates cursor 144 in the appropriate direction at a decreased rate. When the movable object 136 is returned to the center of the basin 134, processor 120 causes cursor 144 to move across the image at a constant rate (e.g., with no acceleration because the distance between the center of basin 134 and the position of movable object 136 is zero). To stop the movement of the cursor 144, the user must move the movable object 136 in a direction that is opposite of the direction of movement of the cursor 144, causing the cursor to decelerate and ultimately stop moving.

It should be noted that although four exemplary modes of operation for controlling cursor 144 in response to movement of movable object 136 are described herein, other modes of operation may also be used. In addition, the cursor control device 110 may be used to interact with menus, lists, or other graphical user interface controls displayed in the display area 142. For example, movement object 136 along the Y-axis of coordinate system 138 may enable the user to scroll through a menu or list that is depicted in the display area 142. Further, movement of object 136 in a positive direction along the X-axis of coordinate system 138 may enable the user to select an object from the menu or list or proceed to a next menu and movement of object 136 in a negative direction along the X-axis of coordinate system 138 may enable the user to undo the last menu selection or move back to a previous menu.

In addition, although the embodiment of the present invention described in FIG. 3 is directed at a system 100 that includes a cursor control device 110 for controlling the movement of a cursor 144 in a display area 142, it should be noted that in other embodiments the devices described above with respect to FIGS. 1 and 2 may be used to control other objects that move on a plane. In these embodiments, the object moves on the plane in response to movement of a movable object (e.g., the movable object 16 of FIG. 1) within in basin (e.g., the basin 14 of FIG. 1) in substantially the same manner as cursor 144 moves in the display area 142 in response to movement of movable object 136 according to a mode of operation as described above.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An apparatus for controlling the movement of an object on a plane, the apparatus comprising:
a basin;
a movable object positioned within the basin: and
a sensor coupled to the apparatus for detecting movement of the movable object within the basin, wherein movement of the movable object on the plane is related to movement of the movable object within the basin.

2. The apparatus of claim 1, further comprising:
a base having a top and a bottom, wherein the top of the base comprises the basin;
an opening extending through the basin; and
a restraint device coupled to the bottom of the base, extending through the opening, and coupled to the movable object for constraining movement of the movable object within, and biasing it toward the center of, the basin.

3. The apparatus of claim 2, wherein:
the basin has a predetermined curvature; and
the movable object comprises a substantially circular disc having a curvature that is substantially complementary to the curvature of the basin.

4. The apparatus of claim 2, wherein the restraint device comprises a spring.

5. The apparatus of claim 2, wherein the sensor comprises an optical sensor.

6. The apparatus of claim 2, wherein the movable object comprises a magnet, and the sensor comprises a Hall Effect sensor configured to detect movement of the magnet.

7. A system for controlling a cursor on an electronic display, the system comprising:
a cursor control device comprising:
a basin;
a movable object positioned within the basin; and
a sensor configured to generate motion signals describing movement of the movable object within the basin; and
a processor coupled to the cursor control device and the electronic display and configured to move the cursor on the electronic display in response to the motion signals from the sensor.

8. The system of claim 7, wherein the cursor control device further comprises:
a base having a top and a bottom, wherein the top of the base comprises the basin;
an opening extending through the center of the basin; and
a spring coupled to the bottom of the base, extending through the opening, and coupled to the movable object for constraining movement of the movable object within, and biasing it toward the center of, the basin.

9. The system of claim 8, wherein:
the basin has a predetermined curvature; and
the movable object comprises a substantially circular disc having a curvature that is substantially complementary to the curvature of the basin.

10. The system of claim 8, wherein the sensor comprises an optical sensor coupled to the basin.

11. The system of claim 8, wherein the movable object comprises a magnet, and the sensor comprises a Hall Effect sensor configured to detect movement of the magnet.

12. The system of claim 8, wherein the processor is further configured to position the cursor on the electronic display at a location that corresponds to the position of the movable object within the basin.

13. The system of claim 8, wherein the processor is further configured to move the cursor on the electronic display in a direction that corresponds to a direction that the movable object moves within the basin.

14. The system of claim 8, wherein the processor is further configured to move the cursor on the electronic display in a direction that corresponds to the position of the movable object with respect to the center of the basin and at a speed that corresponds to a distance between the movable object and the center of the basin.

15. The system of claim 8, wherein the processor is further configured to move the cursor on the electronic display in a direction that corresponds to the position of the movable object with respect to the center of the basin and with an acceleration that corresponds to a distance between the movable object and the center of the basin.

16. The system of claim 8, wherein:
the movable object is movable along a first axis and a second axis within the basin; and
the processor is further configured to:
display a menu on the electronic display, the menu having a plurality of selectable menu items;
scroll through the plurality of selectable menu items based on movement of the movable object along the first axis; and
select a menu item based on movement of the movable object along the second axis.

17. An apparatus for controlling a cursor on an electronic display in a vehicle, the apparatus comprising:
a base having a top and a bottom;
a basin formed in the top of the base;
an opening extending through the center of the basin;
a movable object positioned within the basin:
a spring coupled to the bottom of the base, extending through the opening, and coupled to the movable object for constraining movement of the movable object within, and biasing it toward the center of, the basin; and
a sensor coupled to the apparatus for detecting movement of the movable object within the basin, wherein movement of the cursor on the electronic display is related to movement of the movable object within the basin.

18. The apparatus of claim 17, wherein:
the basin has a predetermined curvature; and
the movable object comprises a substantially circular disc having a curvature that is substantially complementary to the curvature of the basin.

19. The apparatus of claim 17, wherein the sensor comprises an optical sensor coupled to the basin.

20. The apparatus of claim 17, wherein the movable object comprises a magnet, and the sensor comprises a Hall Effect sensor configured to detect the movement of the magnet.
